(19) United States
(12) Patent Application Publication
(10) Pub. No.: US 2009/0297062 A1
(43) Pub. Date: Dec. 3, 2009

(54) Mobile device with wide-angle optics and a radiation sensor

(76) Inventors: Anders L. Molne, Cary, NC (US); Heikki Pylkko, Oulu (FI); Joseph A. Carsanaro, Chapel Hill, NC (US)

Correspondence Address: Ober, Kaler, Grimes & Shriver, 120 East Baltimore Street, Baltimore, MD, 21202-1643, US

(21) Appl. No.: 12/454,562

(22) Filed: May 19, 2009

Related U.S. Application Data
(63) Continuation-in-part of application No. 11/072,679, filed on Mar. 4, 2005, now Pat. No. 7,567,818.

(51) Int. Cl. G06K 9/36

(52) U.S. Cl. 382/289

(57) ABSTRACT

A method and device for displaying content using an integral or remote controller for navigating the content based on dynamic image analysis of the motion of the controller, for example, by tilting. The controller is equipped with wide-angle optics and with a radiation sensor detecting either visible light or infrared radiation. The wide-angle optics may be directed towards the user, whereupon the radiation sensor receives useful images through the wide-angle optics. The images include contrast or thermal differences which it make possible to determine in which way the user has moved the controller. In more detail, a tilt angle or a corresponding change can be calculated and then, on the basis of the change, the content shown on a display is altered. The content is, for example, a menu, game scene or a web page.

### CROSS-REFERENCE TO RELATED APPLICATION(S)

The present application is a continuation-in-part of U.S. application Ser. No. 11/072,679 filed 4 Mar. 2005.

### BACKGROUND OF THE INVENTION

1. Field of the Invention

The present invention relates generally to control techniques for mobile devices such as cellular phones, personal digital assistants (PDAs), PC Tablets, digital cameras, gaming devices, medical equipment, or any other portable electronic device and, more particularly, to controlling techniques by which a user controls the mobile device by moving it.

2. Description of the Background

Over the past few years a number of techniques have been developed to obtain and utilize motion information about a mobile device. One of these techniques is based on the use of accelerometer(s), the mobile device being equipped with at least one accelerometer that continuously measures the motion of the mobile device. On the basis of the measurement results, the mobile device estimates which way a user has tilted the mobile device. For example, the mobile device may calculate the difference in the tilt angle of the current position in comparison to the previous position of the mobile device. Thereafter a certain action is performed on the basis of the tilt angle. For example, if the mobile device presents menu options, the menu options can be scrolled forward or backward according to the tilt angle.

FIG. 1A shows a mobile phone presenting a menu before a tilt. We may assume that the mobile phone 101 is equipped with an accelerometer. The mobile phone 101 presents a menu 102 on its display 103 and said menu contains three options. The options are the names of people whom a user can call by selecting one of the options. Initially, the middle option 104 is highlighted, i.e. the user can select it, for example, by pressing a certain button.

FIG. 1B shows the mobile phone 101 presenting the menu 102 when the user has tilted it to a new position. In more detail, the user has tilted the mobile phone so that the upper edge 105 is now farther away from the user than in the FIG. 1A. The tilt angle from the position of the mobile phone shown in FIG. 1A to the new position is approximately −20 degrees 106. Because of the tilt, the upper option 107 of the menu 102 is now highlighted. Correspondingly, if the user tilts the mobile phone from the position shown in FIG. 1A to another new position so that the upper edge 105 of the mobile phone is closer to the user, the lower option 108 will be highlighted.

FIG. 1C shows the content of the menu 102 after an intense (rapid) tilt. The intensity of the tilt is not necessarily related to the magnitude of the tilt angle, but to how quickly the new position of the mobile phone 101 is achieved. When an intense backward tilt is detected, the menu 102 is scrolled forward, and the menu includes a new menu option 109. Correspondingly, if the user tilts the upper edge 105 of the mobile phone 101 rapidly closer to himself/herself, the menu is scrolled backward.

FIGS. 1B and 1C show examples of received motion information about a mobile device. The said motion information indicates “a longitudinal tilt” of the mobile device. The motion information may also indicate that the user has tilted the right edge 108 of the mobile phone 101 either farther from himself/herself or closer to himself/herself. This is termed a “horizontal tilt.”

A mobile device can be adapted to detect the longitudinal and/or horizontal tilt of the mobile device and to then scroll longitudinally and/or horizontally the content shown on its display. This is a very useful feature, for example, when browsing web pages. The feature makes it possible to browse even large and complicated web pages with a relatively small-sized display.

In the prior art, the motion information of a mobile/portable device can be obtained using one or more accelerometers. Alternatively, the said motion information can be obtained using inclinometers or gyroscopes. Still further, there is optical navigation sensor technology, such as used in Agilent Technologies' optical mouse sensors, which can be used to control devices. Optical imaging is a technique that involves the transmission of light against, for example, the user's finger, and analysis of the deflection of light there from to determine movement.

FIG. 2 shows a portable electronic device equipped with mouse-like capabilities. The device 201 includes a display 202 and a motion sensor 203. The display shows the same menu as in FIG. 1A and the middle option 204 is currently highlighted. When a user moves his/her finger 205 upwards 206, the upper option 207 is highlighted. However, the user must press the finger 205 against the motion sensor 203, or keep the finger very close to it, to be able to control the device 201. The operation of the optical navigation is generally based on sequential reflectance readings received by the motion sensor 203 and the comparative difference in luminance between the readings. The optical navigation and the motion sensor 203 are further described in EP1241616.

The prior art has certain drawbacks. Accelerometers and inclinometers are sensitive to vibration. Therefore a portable device equipped with an accelerometer or an inclinometer may be difficult to control inside of a moving car or when walking. Accelerometer-based devices also have rather limited operating positions. Gyroscopes do not suffer from vibration, but they do suffer from so-called drift. Moreover, gyroscopes are mechanically complicated and more expensive devices. The known implementations of optical navigation also suffer from vibration. Another drawback with the prior art implementations is that a user must use both hands, i.e. the user holds the mobile/portable device in one hand and controls the device with a finger of the other hand. For example, in the device 101 the display 103 is large-sized, almost covering the whole front surface of the device 101. If a motion sensor is plugged into the front surface of the device 101, the user's hand will at least partially cover the display. Thus, the drawbacks inherent in prior art optical navigation and mobile/portable devices are: 1) the user needs both hands for using a mobile/portable device and 2) the user's hand may partially cover the display of said device.

It would be greatly advantageous to provide an improved navigation technique based on the detection of longitudinal and/or horizontal tilt of the mobile device by digital image interpolation that overcomes the drawbacks inherent in prior art optical, accelerometer and gyroscopic navigation mobile/portable devices.

### SUMMARY OF THE INVENTION

According to the present invention, the above-described and other objects are accomplished by providing a mobile device including wide-angle image sensor for capturing digital photo images and/or infrared (IR) radiation images. In addition, said mobile device is equipped with at least a memory, a processor, and a display for showing graphical content. The content may be, for example, web pages, photos, or menus. Said mobile device is adapted to receive and store at least two sequential images from the wide-angle image sensor or radiation sensor in the memory, wherein the first image indicates the first position of the mobile device at the first point in time and a second image indicates a second position of the mobile device at a second point in time. Said mobile device is generally adapted to: determine the change from the first position and the second position of the mobile device by applying a method of motion detection to the first image and the second image, and; to alter the content shown on the display in accordance with the determined change. There are at least two different methods for motion detection which can be applied to the determination of the change. In either case, the change is initiated by moving the mobile device, for example, by tilting or rotating it. The change from the first position to the second position is interpreted, and the interpreted result is applied to alter the content. Different types of changes may have different effects on the content shown on the mobile device display.

The wide-angle optics may comprise a large pixel-count CCD, CMOS or other digital imager, and a wide angle lens for focusing an image (photo or radiation) on the imager. The wide-angle optics are preferably directed towards the user, whereupon the image/radiation sensor receives very useful images through the wide-angle optics. One skilled in the art should understand that the wide-angle optics may alternatively be directed away or askance from the user. Dynamic scene analysis is applied to reveal movement of objects or features in the differential photo images, and/or luminance or thermal differences in the radiation images, which makes it possible to determine in which direction the user has tilted/moved the mobile device. Still another characteristic of the invention is that an inventive mobile device is adapted to detect a change between its current and its new position. The change may be a tilt, but may also be other types of changes between the mobile device's previous and new position, wherein the previous and the new position may be angles or locations.

The change from the first position to the second position is interpreted, and the interpreted result is applied to alter the content. This way, a user needs only one hand to navigate content displayed on a mobile device equipped with a large-sized display.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1A shows a mobile phone presenting a menu before a tilt,

FIG. 1B shows the mobile phone presenting the menu after the tilt,

FIG. 1C shows the content of the menu after an intensive tilt,

FIG. 2 shows a portable electronic device with mouse-like capabilities,

FIG. 3 shows the inventive mobile device,

FIG. 4 shows two examples of longitudinal tilts,

FIG. 5 illustrates the use of a wide-angle lens and a navigation chip,

FIG. 6 shows a cross-section of the inventive mobile device,

FIG. 7A shows a cursor and a corresponding image before a tilt,

FIG. 7B shows the same cursor and a new image after the tilt,

FIG. 7C shows the best-fit offset between the two images,

FIG. 8 illustrates a method of pattern-based motion detection,

FIG. 9 illustrates “zoom in” and “zoom out” operations.

### DETAILED DESCRIPTION OF THE PREFERRED EMBODIMENT

The invention generally comprises a control and navigation system for portable electronic devices such as, for example, a mobile phone, a personal digital assistant (PDA), a digital camera, a video camera, a music player, a medical device, or a game device. The control and navigation system is also suitable for handheld controllers for remote control of desktop game and computer consoles, or any other handheld device that includes a processor, memory, and a display for displaying user-navigable content. Game controllers were traditionally attached by wire to a console and had no display. However, modern remote controllers are wireless, handheld, and have a display.

The control and navigation system comprises a digital imaging device in combination with user-navigation software for motion control of the content shown on the display. The digital imaging device further includes wide-angle optics (a lens or slit) plus a pixel-array image sensor for capturing sequential digital photo images and/or infrared (IR) radiation images. The software analyzes the images and interprets a change position of the mobile device from a first position to a second position by motion detection of the sequential images. It then alters the content shown on the display in accordance with the determined change. The content may be, for example, web pages, menus, game scenes or actions, photos in a photo album, the perspective of a video conference application (where tilting the device alters the displayed picture during the video conference), and many more examples. Said mobile device is adapted to receive and store at least two sequential images from the wide-angle image sensor, to determine the change from the first position and the second position by applying a method of dynamic scene analysis to reveal movement of objects or features, and/or luminance or thermal differences in the sequential images, and to then alter the content shown on the display in accordance with the determined change.

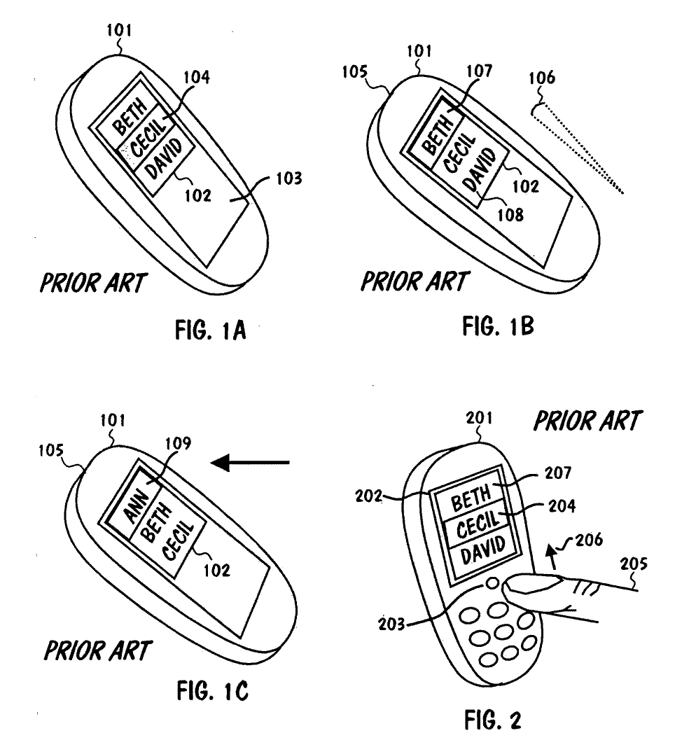

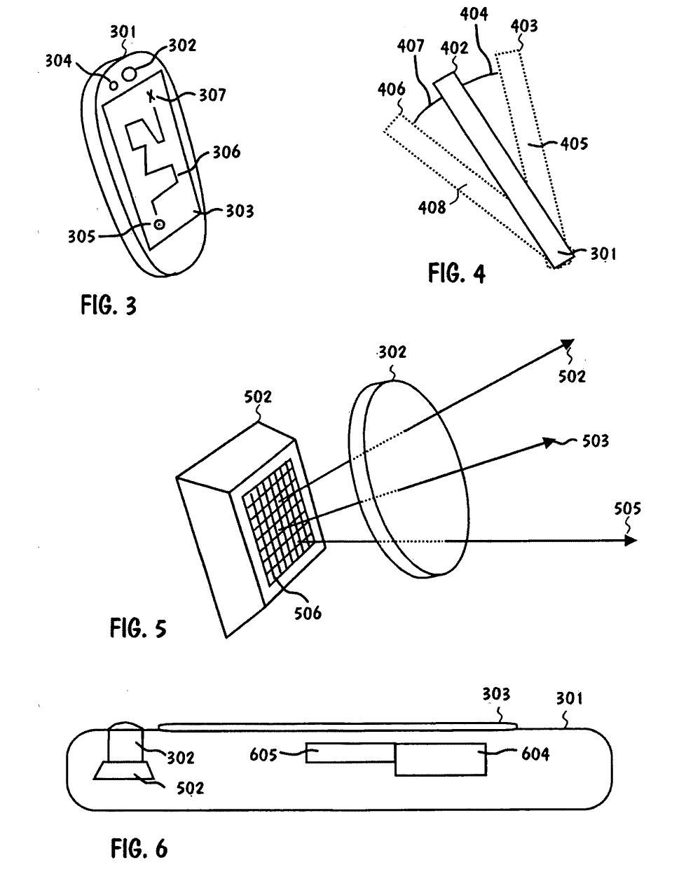

FIG. 3 shows an embodiment of the present invention in the context of a mobile device 301 having a digital imaging device comprising a pixel-array image sensor (here obscured) fronted by a wide-angle lens 302. The mobile device 301 resembles any conventional mobile phone such as the prior art mobile phone 101 of FIGS. 1-4, and one skilled in the art should understand that the mobile device 301 may take the form of a personal digital assistant (PDA), a digital camera, a music player, a game device, or any other portable device having a display for displaying user-navigable content. The wide-angle lens 302 is positioned on the surface of the mobile device 301, preferably on the same side of the mobile device 301 as the display 303, and the pixel-array image sensor is preferably surface-mounted on an internal printed circuit board directly beneath the lens 302. Given this configuration the lens 302 is pointed directly towards the user when the user is viewing the display 303. The mobile device 301 may further include an illumination source 304 such as an LED for creating contrast for capturing images. The lens 302 need not be located on the display side of the mobile device 301. However, if mounted on the backside, images received through the lens 302 may be dark or otherwise poor quality. Users have a tendency to cover the backside with their hand, and if the hand is covering the lens, all the images will be dark and therefore useless for controlling the content shown on the display 303.

In FIG. 3 the content shown on the display of the mobile device 301 relates to an electronic game whereby the user tries to move a ball 305 via a route 306 to a goal 307 by properly tilting the mobile device 301. One skilled in the art should understand that the content may relate to menus, web pages, text menus, game scenes or actions, photos in a photo album, email, or other applications, for example.

The mobile device 301 is adapted to detect one or more characteristics of change between its current angle/location and a new angle/location. These characteristics of change at least include differential angular and linear movement (tilt angle and translation), and may optionally include direction and/or intensity (rate) of change. Therefore the device 301 can detect, for example, longitudinal tilts, horizontal tilts, or simultaneously longitudinal and horizontal tilts.

As an example, FIG. 4 shows two examples of longitudinal tilts when a mobile device 301 is observed from the side. The mobile device 301 is initially located in position 401. If the upper edge 402 of the mobile device 301 is raised so that the upper edge is located at point 403, the tilt angle 404 between the original position 401 of the mobile device and its new position 405 is approximately +15 degrees. Correspondingly, if the upper edge 402 of the mobile device is lowered so that the upper edge 402 is located at point 406, the tilt angle 407 between the original position 401 of the mobile device and its new position 408 is approximately −15 degrees. As can be seen on the basis of FIG. 4, in a longitudinal tilt the upper edge 402 of mobile device 301 moves in relation to the bottom edge 401 of the mobile device. Correspondingly, in a horizontal tilt the right edge of mobile device 301 moves in relation to the left edge.

FIG. 5 illustrates the wide-angle optics, which may comprise any large pixel-count imager 502 such as a CCD, CMOS or other digital imager, plus a wide angle lens 302 for focusing an image (photo or IR radiation) on the imager 502. The wide-angle lens 302 is a very useful component inasmuch as it provides a short focal length, thereby focusing incident radiation rays 503, 504, and 505 from a relatively large area outside of the device onto the imager 502. The large pixel-count imager 502 preferably comprises at least a 640×480 pixel imager, e.g., a VGA (Video Graphics Array) resolution imager. However, a Quarter VGA imager resolution of 320 pixels by 240 pixels (half as high and half as wide as VGA) can also suffice. For a VGA example, given a 640×480 pixel array, each successive image stored by the mobile device 301 is composed of 307.2 k pixels. The mobile device 301 preferably receives at least 25 images per second through the lens 302 and the imager chip 502 (QVGA would allow 14 frames per second). If the pixel array contains less than 64 pixels a user must tilt the mobile device a great deal in order to affect it. Thus, for purposes of the present invention, “wide-angle optics” is herein defined as any pixel-array imaging chip capable of at least 64 pixel resolution, and more preferably a standard 307.2 k resolution or better, plus a focusing lens capable of focusing a full frame wide field image onto the selected imaging chip. In photography, a normal lens for a particular format will have a focal length approximately equal to the length of the diagonal of the pixel array. Thus, for example, if the a 640×480 pixel array imaging chip measures 36 mm by 24 mm, the diagonal measures 43.3 mm and a customary normal lens adopted by most manufacturers would be 50 mm. A normal lens is however often defined to be in the 50-55 mm focal length, with wide angle lens being below 50 mm. Any lens having a focal length of 40 mm or less would be considered wide-angle, and preferred wide-angle lenses for a 35 mm format may range from 10-35 mm.

FIG. 6 shows a cross section of the mobile device 301. This mobile device 301 includes wide-angle optics 302 and pixel array sensor 502, and it is also equipped with at least a memory 604, a processor 605, and a display 303 for showing content. The mobile device 301 is adapted to receive a sequence (at least two) images through the wide-angle optics 302 and the sensor 502, and store the images in the memory 604, wherein a first image indicates the first position of the mobile device at the first point in time and a second image indicates a second position of the mobile device at a second point in time. The processor 605 of the mobile device 601 is adapted to handle at least 25 images per second. Hence, the processor 605 may be configured to record and store a series of still images, or to compress and store sequential video images according to any known PCM-based standard such as MPEG 1-4, H.263, DVD, DivX, XviD, WMV9, AVI, and others. Pulse-code modulation (PCM) is a digitized version of an analog signal sampled regularly at uniform intervals, in binary code. The video display rate or frame rate may vary, and is a balance. A frame rate of 60 frames per second (fps) requires much video storage memory but objects and features are more easily trackable from frame to frame. On the other hand, a frame rate of 25 fps requires much less data but does not have as smooth and normal motion and appears somewhat flickered. Presently, a frame rate of 30 fps is considered ideal. A frame rate of 30 fps may be equivalent to displaying one image frame for approximately 33.33 milliseconds on a display device.

Given two sequential stored frames, the mobile device 301 is adapted to determine the change between the first position and the second position of the mobile device 301 by applying a change detection method to the first image and the second image (either dynamic motion detection for photo images and/or luminance/thermal pattern detection for radiation images. The mobile device 301 then alters the content shown on the display in accordance with the detected change. Tilting is a one example of changing the angle of the mobile device between a first position and a second position. For example, a user lowers the left or right edge of the mobile device. In addition to tilting, the mobile device 301 can be controlled by moving it from one location to another, maintaining the same tilt angle. For example, the user can move the mobile device to the left, or the right in relation to himself/herself. Tilting the left edge of the mobile device may or may not result in the same effect as moving the mobile device to the left of the user. Given two sequential frames the mobile device 301 cannot necessarily distinguish these two different types of motions from each other because both of them result in very similar changes in the image information stored in the memory 604. However, given three or more sequential frames the mobile device 301 can distinguish these two different types of motions from each other by distinguishing a curved movement pattern from a linear pattern. In addition to tilt angle and movement, the mobile device 301 can be controlled by the speed or intensity of the movement. This requires an analysis of the degree of change (either tilting or movement) as a function of time, which is relatively straightforward given that the processor clock results in a consistent frame rate. The present invention includes software that conducts a dynamic motion analysis in real time to measure tilt and translation, or any combination of the two, and optionally measure intensity of movement. The very same concept applies to radiation images which entail objects or characteristics of heat signatures or luminance. In order to apply the motion detection method, the mobile device 301 carries out the following steps: 1A) superimpose at least two images; 2A) calculate a best-fit offset from the first image to the second image based on dynamic image analysis of movement of one or more salient features or objects in the images; and 3A) calculate on the basis of the best-fit offset the change between the first position and the second position of the mobile device. Alternatively, in order to apply the motion detection method the mobile device 301 may be adapted to: 1B) search a location of a predetermined pattern in the first image and in the second image; 2B) calculate an offset between the location of said pattern in the first image and in the second image; and 3C) calculate the change on the basis of the offset.

The mobile device 301 may include an illumination source 304, which is necessary if radiation images are analyzed based on luminosity values. Alternatively, the images may be analyzed based on thermal values, in which case there is no need for an illumination source. Contrast or thermal differences between sequential images (a first and a second image) are essential, because the determination concerning the change of the mobile device 601 is based on these contrast or thermal differences.

The wide-angle optics 302 may be adapted to receive infrared (IR). In this case the lens 302 can be replaced by a slit similar to the slit of a needle-eye camera. The wide-angle optics 302 might also include a light intensifier (also termed “light magnifier” or “light amplifier”), as well as a light filter or other filter for filtering a certain wavelength/wavelengths out of the radiation received by the wide-angle optics.

The radiation sensor 502 is adapted to convert the radiation received through the wide-angle optics 302 into an electronic signal and will generally comprise a pixel array of radiation detectors. It may also be an array of photomultipliers (PMTs) for detection of light in the ultraviolet, visible, and near-infrared ranges of the electromagnetic spectrum.

Next we will describe a motion detection method in which the calculation of the best-fit offset between the images is based on the images' luminosity values.

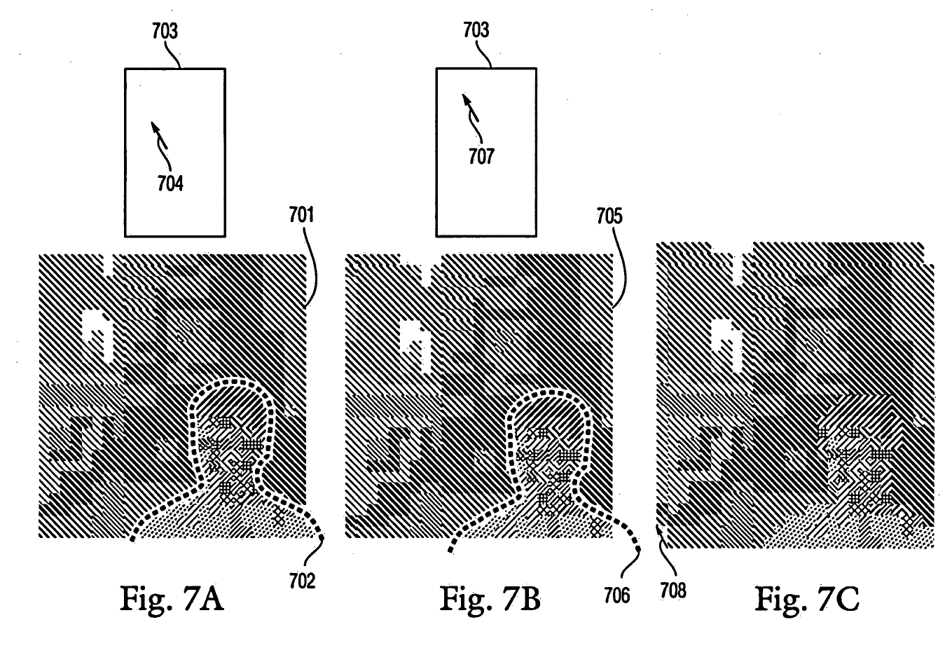

FIG. 7A shows a cursor and a corresponding image before a tilt. We may assume that the mobile device 301 shows the said cursor on its display. The image 701 is composed of 640×480, or 307.2 k pixels. Each of these pixels includes a luminosity value. For example, each optical piece of information 503, 504, and 505 may be a luminosity value, and those values are imaged on a pixel array composed of said 576 pixels. A dashed line 702 illustrating the user's position in the image 701 is added to the image. In other words, the real image 701 received through the wide-angle optics 602 does not include the dashed line 702. Before the tilt the user sees a display 703 and the cursor 704. The other possible content is omitted from the display 703.

FIG. 7B shows the same cursor and a new image after the tilt. Also the new image 705 is composed of 576 pixels, each of them including a luminosity value. The dashed line 706 illustrates the user's new position in the Figure as received through the wide-angle optics, more specifically the position of the user's head and right shoulder. When comparing the dashed line 706 to the dashed line 702 shown in FIG. 7A, it can be noticed that the user's position in FIG. 7B is lower than in FIG. 7A. In addition, the user's position has moved slightly to the right. We can calculate the motion of the user on the basis of the pixels. The result is that the position of the user has moved three pixels downward and one pixel to the right. The new position 707 of the cursor 704 on the display 703 is in accordance with this calculation. The calculation may be based on pattern recognition, whereby the software stores the first image as a reference image and analyzes it to find a subset of pixels in a pattern, which is designated the reference pattern. The coordinates of the reference pattern are stored as well. The reference pattern may be an ad hoc feature of the first image or a predetermined feature that the software is programmed to look for, such as the users face. Given the designated reference pattern found in the first image, the software then analyzes the second and any subsequent images to find the same reference pattern. This is generally accomplished by scanning the pixels of the second image from the upper left corner to the lower right-hand corner to detect the position that best matches the registered image (e.g., the “best fit” match). The coordinates of the reference pattern in the second image are likewise stored. In FIGS. 7A-B, the shape of a user (the dashed lines 702 and 706) is an appropriate choice as the reference pattern to be searched from sequential images. However, the reference pattern could be any easily detected points or areas with high contract levels, such as a persons eyes, contour of body or other sets of points, lines, patterns. The software may also look for multiple reference patterns in the first image and in the second image, such as two eyes and a nose. The advantage is obviously that it is possible to capture more images and process more images over the same time intervals as the complexity of the images is reduced. In either case, two sequential images are compared to determine movement. However, we assume that the calculation concerns a best-fit offset between all or part of the sequential images.

FIG. 7C shows a best-fit offset between the images 701 and 705. These images are superimposed so that the luminosity values of the pixels of the image 705 correspond as precisely as possible to the luminosity values of the pixels of the image 701. There is the best match between the luminosity values when the image 701 is superimposed on the image 705 as shown in FIG. 7C. This is a simplified example of the calculation of the best-fit offset 708 between the first image (shown in FIG. 7A) and the second image (shown in 7B). A person skilled in the art can find detailed descriptions of the calculation of the best-fit offset, for example, by using terms the “best-fit offset” and/or “optical navigation” in Internet searches, and there is commercial software such as, for example, SIGNUM Interactive Image Processing Software. See also, Nakajima et al., Moving-object detection from MPEG coded data, Proc. SPIE Vol. 3309, p. 988-996, Visual Communications and Image Processing '98, which describes a method of moving object detection directly from MPEG coded data.

After the images 701 and 705 are superimposed by the processor which then calculates the best-fit offset between the images, the next operation is the determination of the tilt angle. The mobile device determines the tilt angle between the first position and the second position of the mobile device on the basis of the best-fit off-set between the pixel reference pattern of the first image and the second (and any subsequent) images. In a simple case, the longer the offset the greater the tilt angle. We may assume that the longitudinal tilt of the mobile device 301 is more important than the horizontal tilt and for that reason the mobile device determines at least the longitudinal tilt. When deemed useful, the mobile device may also determine the horizontal tilt.

Finally, the mobile device 301 alters the content shown on its display in accordance with the tilt angle/angles. The mobile device may move a cursor to another position as shown in FIG. 7B. Alternatively, the mobile device may alter the content of a menu as shown in FIG. 1B, for example. Another alternative, relating to FIG. 3 is that the mobile device updates the position of the ball 305 on the route 306. These are just some examples of how the content of the display is altered. The menu operation might also include rotating the device clockwise or counter clockwise around the z-axis (z-axis being 90 degree angle to the display surface) resulting in automatic realignment of the visual content on the display, so that the display content remains in the same orientation (to the user), while the device is rotated.

This invention can be used to manipulate the content within a game application on a mobile phone, PDA, handheld gaming device, or camera (or GPS). When the device is reoriented then new gaming content appears on the screen. An example can be a in a shooting game where the user moves the device 301 in a particular direction such as a target to the left, the screen can orient to and focus in on that portion of the screen which contains that target. Another gaming application example could be in a driving game. As you orient the device (steer or tilt) to the right, the car steers to the right down to follow the right turn in the road. Rather than changing the scene, the motion input to be applied may control the main object, such as cursor or gaming character.

This invention can be used to reorient the image on the screen as a switch from portrait to landscape view mode of that image. For example, when viewing a picture on a camera, mobile phone, PDA, or handheld gaming device the image can switch from portrait to landscape by turning the device. This is also true for web content which may be easier to view in either portrait or landscape mode which can be accommodated by rotating the device to the desired view angle and the content switch to that view mode.

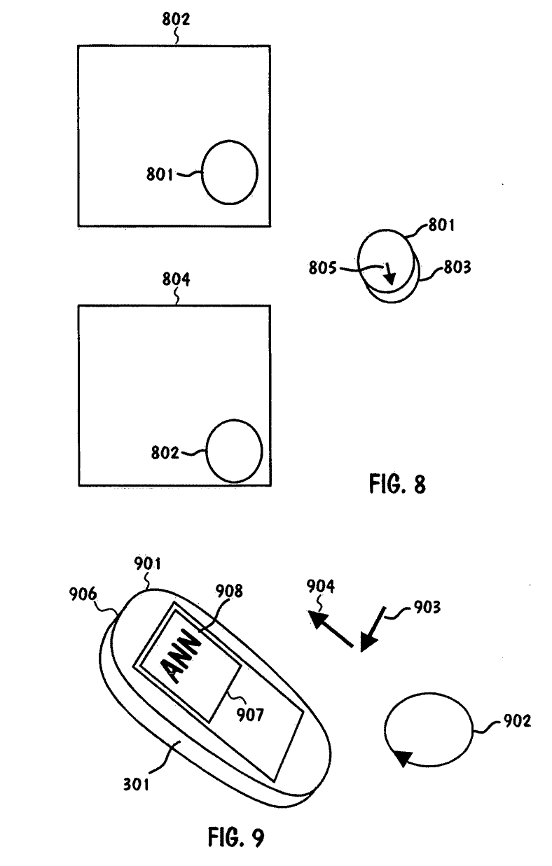

FIG. 8 illustrates the alternative motion detection method based on the search for a predetermined pattern in the images, such as the first and the second image mentioned in FIG. 6. Let us assume that the images are thermal values (they could be luminosity values). Given a predetermined pattern of an ellipse, and assume that the temperature of the ellipse is about 37 degrees Celsius. The ellipse might describe the face of a user. The user and his/her surroundings are the same as in FIG. 7A, but the surroundings are omitted from FIG. 8. The mobile device 601 searches the location 801 of the ellipse in the first image 802 and the location 803 of the ellipse in the second image 804. The mobile device calculates an offset 805 between the locations 801 and 803 of the ellipse. Finally, it calculates the tilt angle of the mobile device or another type of change on the basis of the offset. A person skilled in the art can find detailed descriptions of this method, for example, by using the search word “pattern recognition” in the Internet searches.

Rather than a mobile phone or a personal digital assistant (PDA), the mobile device 301 may be a digital video camera, in which case the wide-angle optics 302 and the radiation sensor 502 may be existing components of the mobile device 301. The mobile device 301 may also be a wireless game controller in communication with a processor and memory in a remote gaming console connected to a television or LCD display, in which case the wide-angle optics 302 and the radiation sensor 502 are added features of the controller.

When the mobile device alters the content of its display, it may perform a certain operation, such as the menu operations shown in FIGS. 1A, 1B, and 1C. In addition to these menu operations, an operation set of the mobile device 301 may also include other types of operations. If the mobile device 301 always responds to the tilt angles one by one, the number of different operations in the operation set of the mobile device is quite limited. In order to enlarge the operation set, the mobile device can be adapted to detect sets of tilt angles. In this case, the mobile device determines that two tilt angles belong to the same set, if the tilt angle of the mobile device changes twice during a certain time period. This way the mobile device can determine, for example, that a user is rotating said mobile device. The user can rotate the mobile device in a clockwise or a counter-clockwise direction. These two directions can be mapped to “zoom in” and “zoom out” operations, for example.

FIG. 9 illustrates the zoom in and the zoom out operations. A user has rotated the mobile device 301 in the clockwise direction 902. The mobile device 301 determines the rotation on the basis of at least two changes when these transactions happen within a predetermined time limit. There are at least three ways to rotate the mobile device in the clockwise direction 902 or in the counter-clockwise direction. First, a user can rotate the mobile device 301 by moving it to the left 903 of himself/herself and then away 904 from him-self/herself. The motion may continue after the changes 903 and 904, but the mobile device can be adapted to determine on the basis of these two changes that it has been moved to the clockwise direction. Secondly, the user can rotate the mobile device 301 by tilting its edges in a certain order, for example: first the left edge 905, then the upper edge 906, then the right edge, and lastly the lower edge. Also in that case two changes may be enough for determining the clockwise direction 902. Thirdly, the user can rotate the mobile device 301 by turning it around an imaginary axis which is perpendicular to the display 907 of the mobile device. It may be enough that the user turns the mobile device less than one-fourth of the full circle. Thus, there are three ways to cause the clockwise rotation direction 902 for the mobile device. In response to the clockwise rotation direction 902, the mobile device 301 may zoom in the content shown on the display 907 of the mobile device. In this example, the content is the simple text “Ann” 908. If the user rotates the mobile device in a counter-clockwise direction, the mobile device may zoom out the text “Ann”, i.e. making it smaller in size.

If required, the mobile device 301 shown in FIG. 6 can detect sets of changes, wherein a certain set of changes is mapped to a certain operation. Therefore, when the change between the first position and the second position meets the first predefined criterion at a certain point in time and when the other change between the first position and the second position meets a second predefined criterion within a predetermined time period starting from that certain point in time, the mobile device 301 is further adapted to perform a predetermined operation on the display of the mobile device. The predefined operation may be, for example, to zoom in or to zoom out the content shown on the display.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

We claim:

1. A method for using a handheld device for controlling content displayed on an electronic display, comprising the steps of:
acquiring a first image at a digital imager integral to said handheld device through a wide-angle lens and storing said first image in a memory;
acquiring a second image at said digital imager through said wide-angle lens and storing said second image in said memory;
analyzing said first image to resolve an image feature contained in said first image;
analyzing said second image to resolve said image feature also contained in said second image;
calculating an offset distance between said image feature in said first image to said image feature in said second image;
altering content displayed on said electronic display in accordance with said calculated offset distance.

2. The method for using a handheld device according to claim 1, wherein said offset distance represents a tilt angle of said handheld device.

3. The method for using a handheld device according to claim 1, wherein said offset distance represents linear movement of said handheld device.

4. The method for using a handheld device according to claim 1, wherein said offset distance represents a combination of tilt angle and linear movement of said handheld device.

5. The method for using a handheld device according to claim 1, wherein said content displayed on said electronic display comprises a menu tree of a plurality of selection options and said step of altering said content displayed on said electronic display comprises scrolling through said plurality of selection options in accordance with said calculated offset distance.

6. The method for using a handheld device according to claim 1, wherein said content displayed on said electronic display comprises a cursor and said step of altering said content displayed on said electronic display comprises moving said cursor in accordance with said calculated offset distance.

7. The method for using a handheld device according to claim 1, wherein said content displayed on said electronic display comprises a background scene and said step of altering said content displayed on said electronic display comprises moving said background scene in accordance with said calculated offset distance.

8. The method for using a handheld device according to claim 1, wherein said content displayed on said electronic display comprises an icon against a background environment and said step of altering said content displayed on said electronic display comprises moving said icon through said background environment in accordance with said calculated offset distance.

9. A method for using a handheld device for controlling content displayed on an electronic display, comprising the steps of:
acquiring a first image at a digital imager integral to said handheld device through a wide-angle lens and storing said first image in a memory;
acquiring a second image at said digital imager through said wide-angle lens and storing said second image in said memory;
acquiring a third image at said digital imager through said wide-angle lens and storing said second image in said memory;
analyzing said first image to resolve an image feature contained in said first image;
analyzing said second image to resolve said image feature also contained in said second image;
analyzing said third image to resolve said image feature also contained in said third image;
calculating a first offset distance and a first offset direction between said image feature in said first image to said image feature in said second image;
calculating a second offset distance and a second offset direction between said image feature in said second image to said image feature in said third image;
altering content displayed on said electronic display in accordance with said calculated first and second offset distances and first and second offset directions.

10. The method for using a handheld device according to claim 9, further comprising a step analyzing said first offset distance and first offset direction and said second offset distance and second offset direction to determine a tilt angle of said handheld device.

11. The method for using a handheld device according to claim 9, further comprising a step analyzing said first offset distance and first offset direction and said second offset distance and second offset direction to determine linear translation of said handheld device.

12. The method for using a handheld device according to claim 9, further comprising a step analyzing said first offset distance and first offset direction and said second offset distance and second offset direction to determine both tilt angle and linear translation of said handheld device.

13. The method for using a handheld device according to claim 9, wherein said steps of acquiring said first image, acquiring said second image, and acquiring said third image at said digital imager all further comprise acquiring sequential frame video images.

14. The method for using a handheld device according to claim 13, wherein said sequential frame video images are stored in a standard PCM-based video format.

15. The method for using a handheld device according to claim 9, wherein said content displayed on said electronic display comprises a menu tree of a plurality of selection options and said step of altering said content displayed on said electronic display comprises scrolling through said plurality of selection options in accordance with said calculated offset distance.

16. The method for using a handheld device according to claim 9, wherein said content displayed on said electronic display comprises a cursor and said step of altering said content displayed on said electronic display comprises moving said cursor in accordance with said calculated offset distance.

17. The method for using a handheld device according to claim 9, wherein said content displayed on said electronic display comprises a background scene and said step of altering said content displayed on said electronic display comprises moving said background scene in accordance with said calculated offset distance.

18. The method for using a handheld device according to claim 1, wherein said content displayed on said electronic display comprises an icon against a background environment and said step of altering said content displayed on said electronic display comprises moving said icon through said background environment in accordance with said calculated offset distance.

19. In a handheld device comprising a processor, memory, and an electronic display for showing content, a content navigation system for altering content displayed on said electronic display in accordance with motion of said handheld device, said content navigation system further comprising:
a digital imager including wide-angle optics and a pixel-array imager for acquiring a plurality of sequential images and storing said images in said memory; and
software resident in said memory for instructing said processor to analyze said plurality of acquired images to detect an image feature common to said plurality of acquired images, for calculating an offset distance between said image feature on said plurality of acquired images, and for altering content displayed on said electronic display in accordance with said calculated offset distance.

20. The handheld device according to claim 19, wherein said pixel-array imager comprises any one from among the group consisting of a CCD imager, CMOS imager.

21. The handheld device according to claim 19, wherein said pixel-array imager comprises a radiation sensor.

22. The handheld device according to claim 20, wherein said wide-angle optics comprises a wide field lens.

23. The handheld device according to claim 21, wherein said wide-angle optics comprises a slot.

24. The handheld device according to claim 21, wherein said software resident in said memory detects a pixel pattern common to said plurality of acquired images.

25. The handheld device according to claim 21, wherein said software resident in said memory detects a pixel pattern common to said plurality of acquired images by a best-fit pixel comparison.

26. In a device comprising a processor, memory, a handheld controller in communication with said processor, and an electronic display for showing content, a content navigation system for altering content displayed on said electronic display in accordance with motion of said handheld device, said content navigation system further comprising:
a digital imager integral to said controller and including wide-angle optics and a pixel-array imager for acquiring a plurality of sequential widefield images and communicating and storing said images in said memory; and
software resident in said memory for instructing said processor to analyze said plurality of acquired images to detect an image feature common to said plurality of acquired images, for calculating an offset distance between said image feature on said plurality of acquired images, and for altering content displayed on said electronic display in accordance with said calculated offset distance.

27. The device according to claim 26, wherein said pixel-array imager comprises a CCD imager.

28. The device according to claim 26, wherein said pixel-array imager comprises a radiation sensor.

29. The device according to claim 27, wherein said wide-angle optics comprises a wide field lens.

30. The device according to claim 28, wherein said wide-angle optics comprises a slot.

31. The device according to claim 26, wherein said software resident in said memory detects a pixel pattern common to said plurality of acquired images.

32. The device according to claim 26, wherein said software resident in said memory detects a pixel pattern common to said plurality of acquired images by a best-fit pixel comparison.
